(19) United States
(12) Patent Application Publication
(10) Pub. No.: US 2014/0210388 A1
(43) Pub. Date: Jul. 31, 2014

(54) MOTOR CONTROL DEVICE

(71) Applicants: Kazumasa Ito, Chiyoda-ku (JP); Tetsuya Tanabe, Chiyoda-ku (JP)

(72) Inventors: Kazumasa Ito, Chiyoda-ku (JP); Tetsuya Tanabe, Chiyoda-ku (JP)

(73) Assignee: MITSUBISHI ELECTRIC CORPORATION, Chiyoda-ku, Tokyo (JP)

(21) Appl. No.: 14/238,620

(22) PCT Filed: Sep. 22, 2011
(86) PCT No.: PCT/JP2011/071592

§ 371 Date: Feb. 12, 2014

(51) Int. Cl. H02P 6/10

(52) U.S. Cl. CPC H02P 6/10
USPC 318/400.2

(57) ABSTRACT

A motor control device stores correction wave information in a storing unit in advance, monitors a state amount (a torque command or motor speed) specifying a driving state for causing a pulsation in generated torque of a motor, selects, from a storing unit, correction wave information corresponding to positive or negative of the state amount, and generates a sine wave-like correction wave with respect to a periodical torque pulsation (a torque ripple or cogging torque) based on the selected correction wave information, and controls the motor based on a corrected torque command obtained by combining the torque command and the generated correction wave, instead of the torque command input from a host apparatus to control the motor.

### FIELD

The present invention relates to a motor control device and, more particularly, to a motor control device that controls to drive a motor including a permanent magnet.

### BACKGROUND

A motor generates torque depending on relative angles of a stator and a rotor. However, torque generated by a motor including a permanent magnet is pulsating while having a harmonic component. The pulsation of the torque is divided into the following two pulsations: one is a pulsation called torque ripple, the amplitude of which changes according to the magnitude of generated torque and the other is a pulsation called cogging torque, the amplitude of which indicates a fixed value irrespective of the magnitude of generated torque. Such a pulsation of the torque also causes speed unevenness and a positional deviation of the motor. Therefore, various attempts for reducing the torque pulsation in a controlled manner have been performed (e.g., Patent Literatures 1 to 3).

For example, Patent Literature 1 discloses a technology of prediction control for dividing a pulsation of torque into cogging torque of a fixed amplitude type that does not depend on generated torque of a motor and a torque ripple of a variable amplitude type that is proportional to the generated torque, predicting a motor angle at time when reflected on actual torque, and correcting the torque ripple. Patent Literature 1 also discloses a technology for storing respective correction data of the cogging torque and the torque ripple in a storage device as N data corresponding to angles of one rotation of the motor (0 degree≦θn<360 degrees: n=1, 2, . . . , and N).

For example, in Patent Literature 2, a correction wave of a torque ripple is selected as data of an amplitude and a phase for each of frequencies and m sine wave signals are created and combined, whereby the correction wave of the torque ripple is obtained. Patent Literature 2 argues that some torque ripple is not integer times as large as an electrical angular frequency of a motor and discloses a torque ripple correcting method for eliminating a torque ripple that depends on a machine position of the motor.

For example, Patent Literature 3 discloses a technology for selecting, according to positive or negative of output torque, parameters of a phase and an amplitude for correcting a sixth harmonic component of a torque ripple and controlling to drive a motor using a correction wave based on the parameters.

### CITATION LIST

### Patent Literature

Patent Literature 1: Japanese Patent Laid-Open No. H11-299277

Patent Literature 2: Japanese Patent Laid-Open No. 2005-80482

Patent Literature 3: Japanese Patent Laid-Open No. 2010-239681

### SUMMARY

### Technical Problem

However, in the technology described in Patent Literature 1, the correction data of the cogging torque and the torque ripple is stored in the storage device as the N data corresponding to the angles of one rotation of the motor (0 degree≦θn<360 degrees: n=1, 2, . . . , and N). Therefore, there is a problem in that, to perform accurate torque ripple correction, the capacity of the storage device necessary for a control device increases.

In the technology described in Patent Literature 2, Patent Literature 2 argues that some torque ripple is not integer times as large as electrical angular frequency of a motor. However, Patent Literature 2 neither discloses nor indicates a specific method concerning selection of the angular frequency. A further technical development is requested to obtain a satisfactory torque ripple correction effect.

In the technology described in Patent Literature 3, Patent Literature 3 discloses the technology for changing the amplitude and the phase of a correction wave of a torque ripple according to positive or negative of torque. However, Patent Literature 3 neither discloses nor indicates a correction method concerning cogging torque. Concerning an angular frequency, Patent Literature 3 only describes an electrical sixth harmonic. A further technical development is requested to perform more satisfactory torque ripple correction.

The present invention has been devised in view of the above and it is an object of the present invention to obtain a motor control device that can perform, with a simple configuration, correction for appropriately reducing two kinds of torque pulsations according positive or negative of a state amount specifying a driving state for causing a pulsation in generated torque of a motor.

### Solution to Problem

The present invention is directed to a motor control device that achieves the object. One aspect of the present invention relates to a motor control device for controlling a motor based on an input torque command. The motor control device includes: a positive-negative determining unit for determining positive or negative by indicating whether a state amount specifying a driving state for causing a pulsation in generated torque of the motor is positive polarity or negative polarity; a correction-wave-information selecting unit for selecting, from a storing unit that stores correction wave information, correction wave information corresponding to positive or negative indicated by a determination result of the positive-negative determining unit; and a correction-wave generating unit for generating a sine wave-like correction wave with respect to a periodical torque pulsation, based on the selected correction wave information. The motor control device controls the motor based on a corrected torque command obtained by combining the torque command and the generated correction wave, instead of the input torque command.

### Advantageous Effects of Invention

According to the present invention, the motor control device stores the correction wave information in the storing unit in advance, monitors the state amount (the torque command or the motor speed) specifying the driving state for causing a pulsation in the generated torque of the motor, selects, from the storing unit, the correction wave information corresponding to whether the state amount is positive in polarity or negative in polarity, generates the sine wave-like correction wave with respect to the periodical torque pulsation (a torque ripple or cogging torque) based on the selected correction wave information, and controls the motor based on the corrected torque command obtained by combining the torque command and the generated correction wave, instead of the torque command input from a host apparatus to control the motor. Therefore, there is an effect that correction for appropriately reducing two kinds of pulsations (a torque ripple and cogging torque) of torque can be performed.

### BRIEF DESCRIPTION OF DRAWINGS

FIG. 1 is a block diagram of a configuration example of a motor driving system applied with a motor control device according to a first embodiment of the present invention.

FIG. 2 is a block diagram of the configuration of a motor control device according to the first embodiment of the present invention shown in FIG. 1.

FIG. 3 is a block diagram of a configuration example of a torque control unit shown in FIG. 2.

FIG. 4 is a diagram showing torque pulsation waveforms at the time of generation of positive torque and negative torque.

FIG. 5 is a diagram of amplitudes of results obtained by subjecting the torque pulsation waveforms shown in FIG. 4 to Fourier series expansion.

FIG. 6 is a diagram of phase offsets of the results obtained by subjecting the torque pulsation waveforms shown in FIG. 4 to the Fourier series expansion.

FIG. 7 is a block diagram of the configuration of a motor control device according to a second embodiment of the present invention.

FIG. 8 is a block diagram of a configuration example of a torque control unit shown in FIG. 7.

FIG. 9 is a block diagram of the configuration of a motor control device according to a third embodiment of the present invention.

FIG. 10 is a block diagram of a configuration example of a torque control unit shown in FIG. 9.

FIG. 11 is a diagram for explaining an example of stored contents of four correction-waveform-information storing units shown in FIG. 10.

FIG. 12 is a diagram for explaining a relation between an amplitude ratio of a harmonic (a correction wave) and an absolute value of a torque command.

FIG. 13 is a block diagram of another configuration example of the torque control unit shown in FIG. 9 shown as a fourth embodiment of the present invention.

FIG. 14 is a block diagram of a configuration example of a motor driving system including a motor control device according to a fifth embodiment of the present invention.

FIG. 15 is a block diagram of a configuration example of a motor driving system including a motor control device according to a sixth embodiment of the present invention.

FIG. 16 is a conceptual diagram of a configuration example of a driven motor shown as a seventh embodiment of the present invention.

FIG. 17 is a conceptual diagram of another configuration example of the driven motor shown as the seventh embodiment of the present invention.

FIG. 18 is a diagram for explaining a flow of a magnetic flux flowing when a driving force is generated by the motor shown in FIGS. 16 and 17.

FIG. 19 is a diagram of a torque ripple waveform in a motor cross section of the motor shown in FIGS. 16 and 17.

### DESCRIPTION OF EMBODIMENTS

Embodiments of a motor control device according to the present invention are explained in detail below based on the drawings. Note that the present invention is not limited by the embodiments.

### First Embodiment

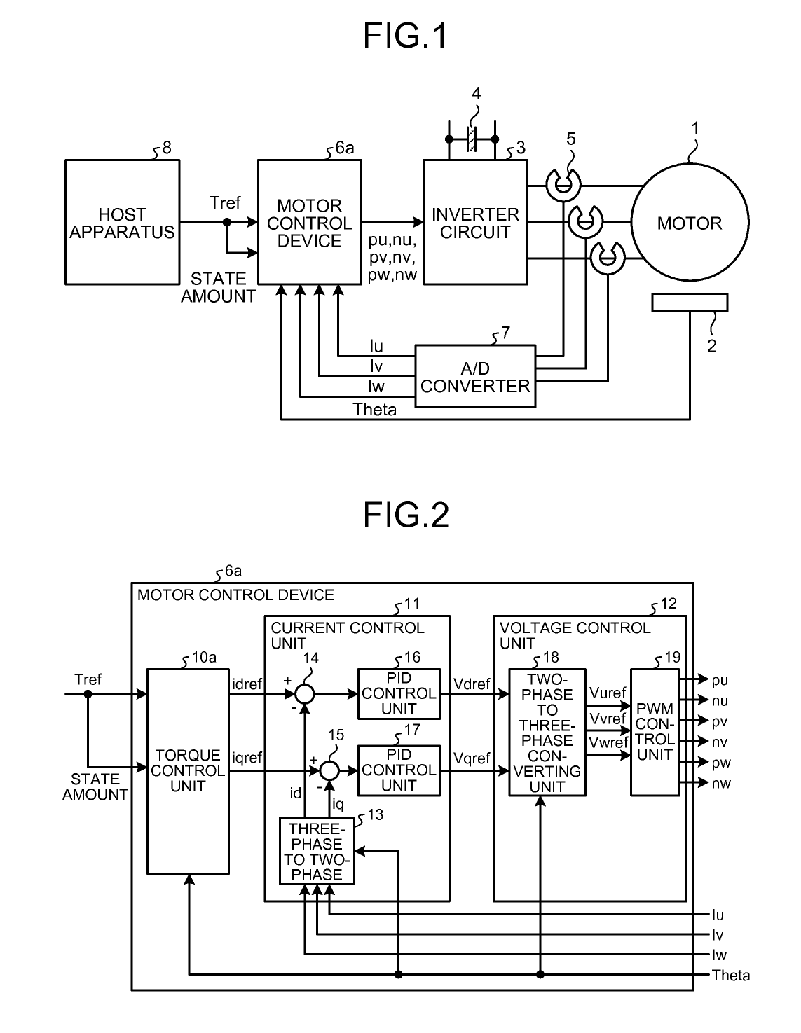

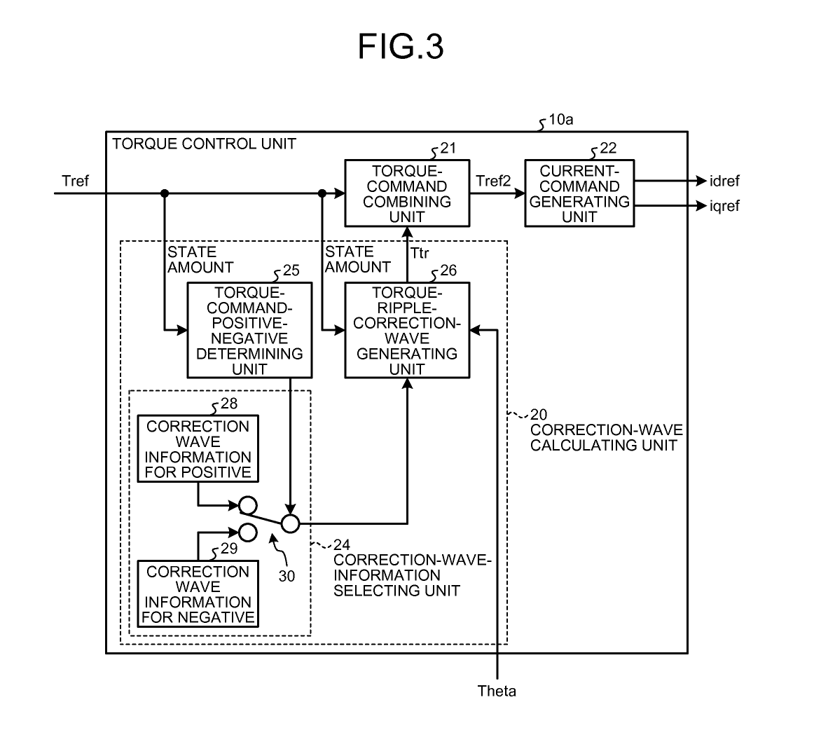

FIG. 1 is a block diagram of a configuration example of a motor driving system applied with a motor control device according to a first embodiment of the present invention. FIG. 2 is a block diagram of the configuration of a motor control device according to the first embodiment of the present invention shown in FIG. 1. FIG. 3 is a block diagram of a configuration example of a torque control unit shown in FIG. 2. In the first embodiment, a correction system for reducing a torque ripple in a pulsation of generated torque is explained.

First, an overview of an applied system is briefly explained.

In FIG. 1, a motor 1 is a motor including a permanent magnet. The motor 1 generates a torque ripple and a cogging torque as a torque pulsation. A position sensor 2 is attached to the motor 1. An inverter circuit 3 includes a three-phase bridge circuit formed by a plurality of switching elements (in general, IGBTs or MOSFETs are used). A capacitor 4 is a direct-current power supply that accumulates direct-current power, which serves as a power source of the motor 1, according to a well-known method. Current sensors 5 are arranged in a power cable that connects the inverter circuit 3 and the motor 1.

The three-phase bridge circuit in the inverter circuit is formed and arranged between a positive terminal and a negative terminal of the capacitor 4, which is the direct-current power supply. Specifically, the three-phase bridge circuit is formed between the positive terminal and the negative terminal of the capacitor 4 in a form in which two switching elements are connected in series as a pair and three series circuits of the two switching elements are connected in parallel.

Driving signal pu, nu, pv, nv, pw, and nw for turning on and off of the plurality of switching elements included in the three-phase bridge circuit are input to the inverter circuit 3 from a motor control device 6a according to the first embodiment. Then, the direct-current power accumulated in the capacitor 4 is converted into three-phase alternating-current power having arbitrary frequencies and arbitrary voltages by a switching operation of the plurality of switching elements and supplied to the motor 1. Consequently, the motor 1 is driven to rotate and predetermined torque is generated in the motor 1.

A motor position Theta at this point is detected by the position sensor 2 and input to the motor control device 6a according to the first embodiment as a feedback signal. Three-phase motor currents flowing to the motor 1 at this point are detected by the current sensors 5, digitized and converted into three-phase digital motor currents Iu, Iv, and Iw by an A/D converter 7, and input to the motor control device 6a according to the first embodiment as a feedback signal.

The motor control device 6a according to the first embodiment calculates and generates the driving signals pu, nu, pv, nv, pw, and nw to the inverter circuit 3 as in the past based on the torque command Tref output by a host apparatus 8, the motor position Theta, which is the feedback signal, and the three-phase digital motor currents Iu, Iv, and Iw.

At this point, the motor control device 6a according to the first embodiment captures the torque command Tref, which is output by the host apparatus 8, as a state amount specifying a driving state for generating one (a torque ripple) of two kinds of torque pulsations, performs, based on the state amount and the motor position Theta, control for reducing a periodically generated torque ripple, and reflects a result of the control on the calculation and the generation of the driving signals pu, nu, pv, nv, pw, and nw given to the inverter circuit 3.

Components related to the first embodiment are specifically explained below. The motor control device 6a includes, as shown in FIG. 2, a torque control unit 10a, a current control unit 11, and a voltage control unit 12.

The torque control unit 10a performs, for example, with the configuration shown in FIG. 3 explained below, as the conventional operation, a calculation of current commands idref and iqref of a d axis and a q axis given to the current control unit 11 according to the torque command Tref from the host apparatus 8 according to the torque command Tref from the host apparatus 8. In addition to the conventional operation, in the first embodiment, the torque control unit 10a captures the torque command Tref, which is output from the host apparatus 8, as a state amount specifying a driving state of the motor 1 for generating a torque ripple, performs, based on the state amount and the motor position Theta, control for reducing a periodically generated torque ripple, and reflects a result of the torque ripple reducing control on the current commands idref and iqref of the d axis and the q axis given to the current control unit 11. This operation is specifically explained below.

The current control unit 11 includes a three-phase to two-phase converting unit 13, subtracters 14 and 15, and, for example, PID control units 16 and 17. Note that PI control units are sometimes used instead of the PID control units 16 and 17.

The three-phase to two-phase converting unit 13 converts the three-phase digital motor currents Iu, Iv, and Iw digitized by the A/D converter 7 into a d-axis current id and a q-axis current iq in the motor position Theta. The subtracter 14 calculates a difference (a d-axis current deviation) between the d-axis current command idref output by the torque control unit 10a and the d-axis current id converted and output by the three-phase to two-phase converting unit 13 and outputs the difference to the PID control unit 16. The subtracter 15 calculates a difference (a q-axis current deviation) between the q-axis current command iqref output by the torque control unit 10a and the q-axis current iq converted and output by the three-phase to two-phase converting unit 13 and outputs the difference to the PID control unit 17. The PID control units 16 and 17 perform PID control for reducing the current deviations of the d axis and the q axis output by the subtracters 14 and 15 and set the d-axis voltage command Vdref and the q-axis voltage command Vqref given to the voltage control unit 12.

The voltage control unit 12 includes a two-phase to three-phase converting unit 18 and a PWM control unit 19.

The two-phase to three-phase converting unit 18 converts the d-axis voltage command Vdref and the q-axis voltage command Vqref output by the current control unit 11 into three-phase voltage commands Vudref, Vvdref, and Vwdref in the motor position Theta. The PWM control unit 19 generates the driving signals pu, nu, pv, nv, pw, and nw, which are PWM signals, from the three-phase voltage commands Vudref, Vvdref, and Vwdref converted and output by the two-phase to three-phase converting unit 18 and outputs the driving signals pu, nu, pv, nv, pw, and nw.

As shown in FIG. 3, the torque control unit 10a has a configuration in which a correction-wave calculating unit 20 and a torque-command combining unit 21 are added to an input stage of a current-command generating unit 22. The correction-wave calculating unit 20 includes a correction-wave-information selecting unit 24, a torque-command-positive-negative determining unit 25, and a torque-ripple-correction-wave generating unit 26. The correction-wave-information selecting unit 24 includes a storing unit 28 configured to store correction wave information for positive, a storing unit 29 configured to store correction wave information for negative, and a selection circuit 30.

The torque command Tref output by the host apparatus 8 is input to the torque-command combining unit 21 and input to the torque-command-positive-negative determining unit 25 and the torque-ripple-correction-wave generating unit 26 as a state amount specifying a driving state of the motor 1. An output (correction wave information) of the selection circuit 30 and the motor position Theta are input to the torque-ripple-correction-wave generating unit 26.

The torque-command-positive-negative determining unit 25 determines positive or negative indicating whether the torque command Tref input from the host apparatus 8 is positive in polarity or negative in polarity and outputs a result of the determination to the selection circuit 30. The selection circuit 30 selects, according to the determination result of the torque-command-positive-negative determining unit 25, the correction wave information stored in one of the storing unit 28 and the storing unit 29 and outputs the correction wave information to the torque-ripple correction-wave generating unit 26.

The torque-ripple-correction-wave generating unit 26 generates, based on the torque command Tref (i.e., the state amount of the motor 1) input from the host apparatus 8 and the correction wave information selected by the selection circuit 30, a sine wave-like torque ripple correction wave Ttr in the motor position Theta and outputs the torque ripple correction wave Ttr to the torque-command combining unit 21. The amplitude of the torque ripple correction wave Ttr depends on the amplitude of torque generated according to the torque command Tref.

The torque-command combining unit 21 combines the torque command Tref input from the host apparatus 8 and the torque ripple correction wave Ttr generated by the torque-ripple-correction-wave generating unit 26 and generates a corrected torque command Tref2.

The current-command generating unit 22 generates, based on the corrected torque command Tref2 generated by the torque-command combining unit 21, a d-axis current command idref and a q-axis current command iqref and outputs the d-axis current command idref and the q-axis current command iqref to the current control unit 11. Consequently, a correction operation for reducing a torque ripple in generated torque of the motor 1 is implemented according to cooperated work of the current control unit 11 and the voltage control unit 12.

The correction wave information stored in the storing units 28 and 29 is explained. The correction wave information used for the generation of the torque ripple correction wave Ttr includes harmonic order information, a ratio of the amplitude of a harmonic (a correction wave) to the torque command Tref (an amplitude ratio), and a phase (an offset phase) of the harmonic (the correction wave). In the storing units 28 and 29, the harmonic order information and the amplitude ratio and the phase (the offset phase) corresponding to the harmonic order information are stored in association with each other.

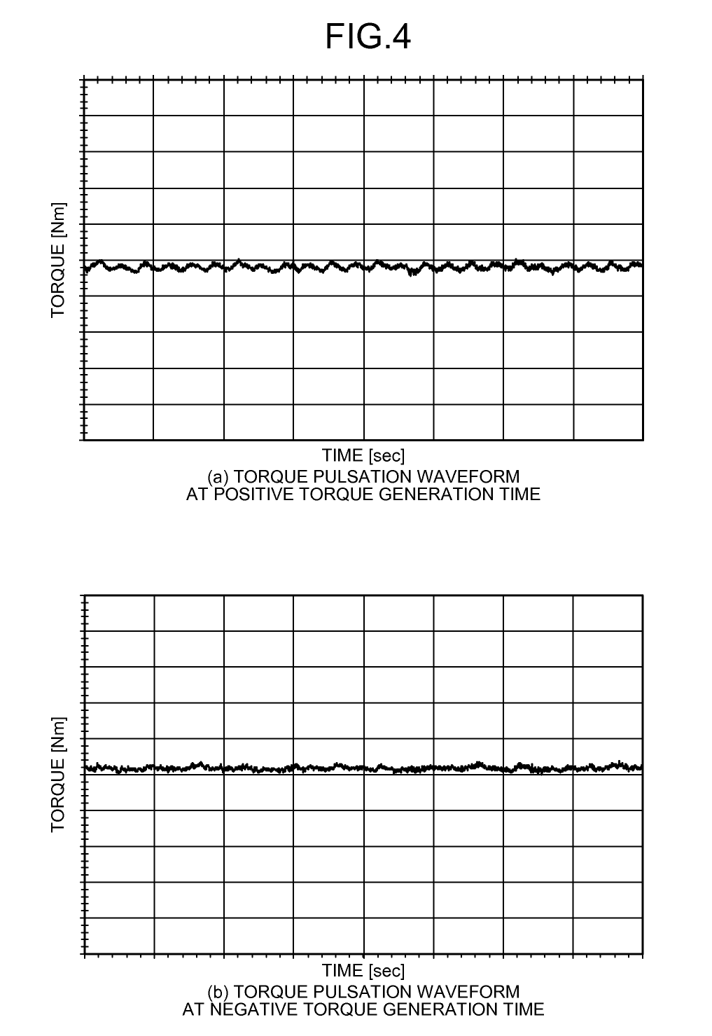

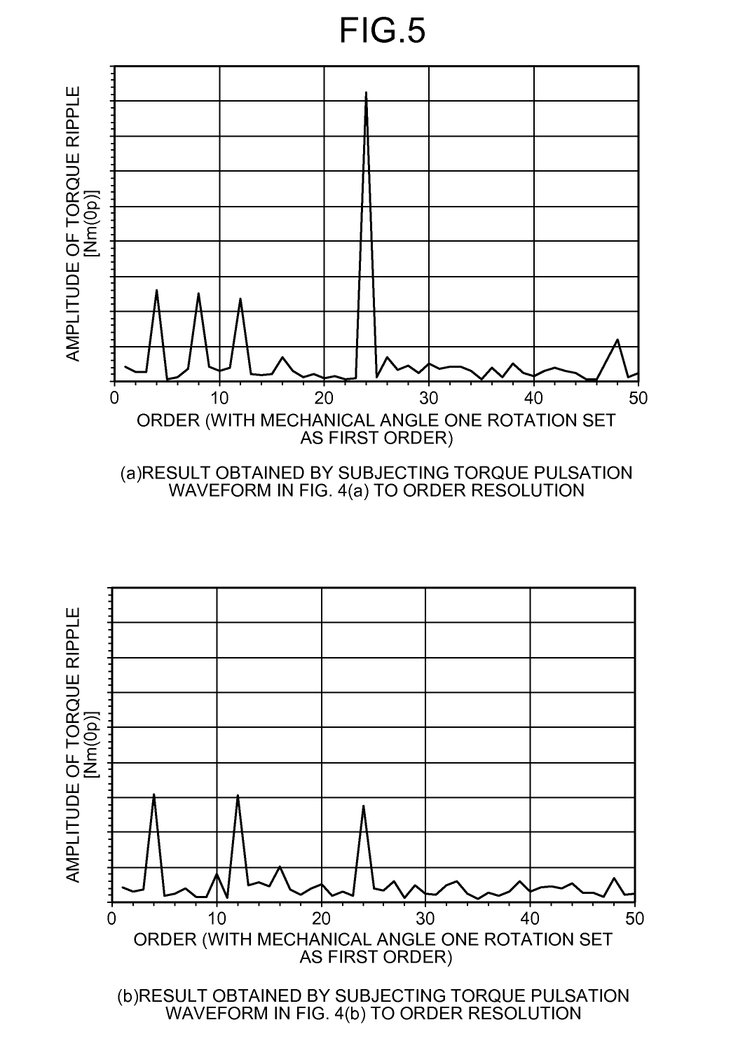

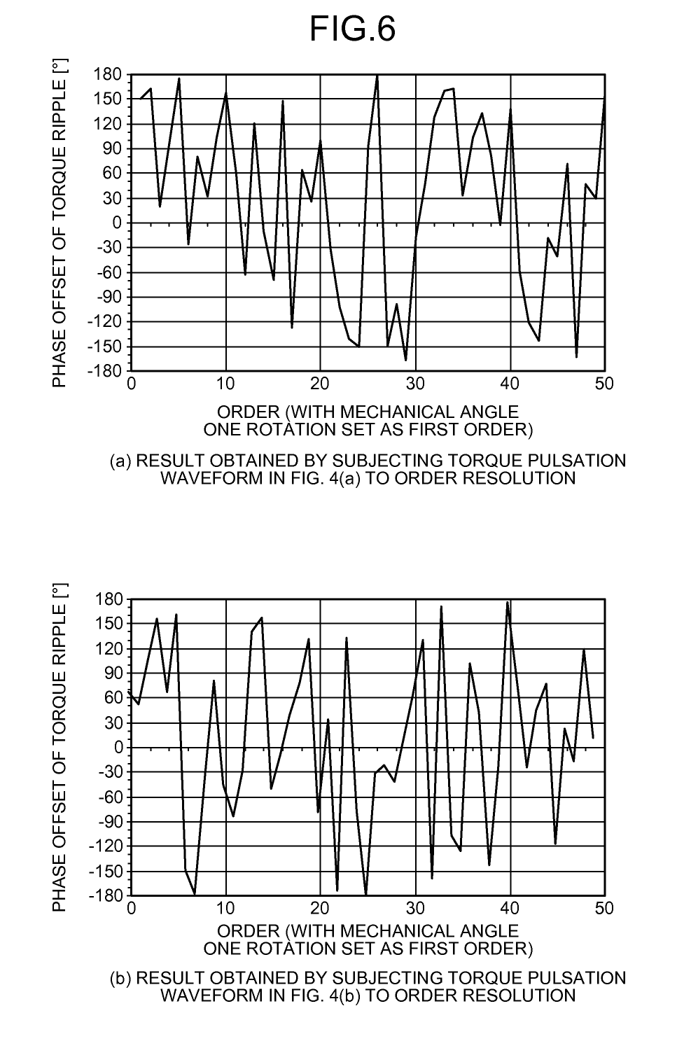

When the motor 1 generates torque, a harmonic order component of a torque pulsation (i.e., a torque ripple) is different according to whether the generated torque is positive in polarity or negative in polarity. First, this point is specifically explained. Note that FIG. 4 is a diagram of torque pulsation waveforms at the time of generation of positive torque and negative torque. FIG. 5 is a diagram of amplitudes of results obtained by subjecting the torque pulsation waveforms shown in FIG. 4 to Fourier series expansion. FIG. 6 is a diagram of phase offsets of results obtained by subjecting the torque pulsation waveforms shown in FIG. 4 to the Fourier series expansion.

A torque pulsation waveform at positive torque generation time is shown in FIG. 4(a). A torque pulsation waveform at negative torque generation time is shown in FIG. 4(b). Results obtained by experimentally acquiring, with a torque meter, torque pulsation waveform of torque generated by applying a fixed load to the motor 1 while rotating the motor 1 in the same rotating direction are shown in FIGS. 4(a) and 4(b). In an experiment, absolute values of time averages of torque are set to be the same. It is seen that the torque pulsation waveforms are clearly different in FIGS. 4(a) and 4(b).

In FIG. 5, an eighth order and a forty-eighth order are generated at positive torque generation time shown in FIG. 5(a). However, an eighth order and a forty-eighth order are hardly generated at negative torque generation time shown in FIG. 5(b). Therefore, it is seen that, when a torque pulsation at positive torque generation time is corrected, it is preferable to generate correction wave of the eighth order and the forth-eighth order but, when a torque pulsation at negative torque generation time is corrected, it is preferable for efficiency of a calculation time not to generate correction waves of the eighth order and the forty-eighth order. As a result, it is possible to reduce the capacity of a storing unit that stores harmonic order information, which is correction wave information.

Therefore, the motor control device 6a according to the first embodiment is configured to, when the motor 1 generates torque, separately prepare the storing unit for positive 28 and the storing unit for negative 29 focusing on a point that a harmonic order component of a torque pulsation (i.e., a torque ripple) is different according to whether the generated torque is positive in polarity or negative in polarity, store correction wave information for positive mainly including harmonic order information for positive in the storing unit 28 and store correction wave information for negative mainly including harmonic order information for negative in the storing unit 29 in advance, make it possible to select harmonic order information corresponding to positive or negative of the torque command Tref, which is the state amount of the motor, according to the positive or negative of the torque command Tref, and generate a torque ripple correction wave based on the selected harmonic order information and the motor position Theta.

At this point, the rotary machine frequency of the motor 1 depends on rotating speed. The motor 1 driven by alternating-current power frequency-converted by the inverter circuit 3 can rotate at various kinds of rotating speed. Therefore, as the harmonic order information stored in the storing units 28 and 29, it is preferable to set the rotary machine frequency of the motor 1 as one order and store a plurality of harmonic orders consisting of multiples n (n is a natural number) of the one order. Then, for example, when torque of the motor 1 rotating at 50 Hz, which is a component oscillating at 100 Hz, is corrected, “n=2” can be set. Therefore, it is possible to perform appropriate correction.

There has also been an idea for setting an electric frequency as one order. However, with this idea, it is difficult to cope with an order decimal times as large as an electrical angular frequency due to fluctuation in the permanent magnet included in the motor 1 and other machining errors. Therefore, it is preferable to set harmonic orders with the rotary machine frequency set as one order.

As the correction wave information stored in the storing units 28 and 29, besides the harmonic order information, it is preferable to store, in association with the harmonic order n, an amplitude ratio An of a torque ripple correction wave (i.e., a harmonic component) generated by the torque-ripple-correction-wave generating unit 26 in response to the torque command Tref and a phase offset amount θn. Then, as shown in FIG. 5, the amplitude of a twenty-fourth order is greatly different at positive torque time (a) and at negative torque time (b). An effect of reducing a torque pulsation (a torque ripple) is considered to be larger when the amplitude ratio An is simultaneously switched rather than simply switching only the order n. The same holds true concerning the phase offset amount θn.

In FIG. 6, it is seen that the phase offset amount θn is different at positive torque generation time (a) and at negative torque generation time (b). For example, the phase offset amount θn of a twenty-fourth order harmonic is −150° in the case of the positive torque generation time (a) and +135° in the case of the negative torque generation time (b) and is different at the positive torque generation time (a) and the negative torque generation time (b). Therefore, it is preferable to switch the phase offset amount θn simultaneously with the harmonic order n.

When the sine wave-like torque ripple correction waveform Ttr generated by the torque-ripple-correction-wave generating unit 26 is represented as a numerical formula using the multiple (the harmonic order) n, the amplitude ratio An of the harmonic (the torque ripple correction wave Ttr), and the phase offset amount θn, the numerical formula is as indicated by Formula (1).

$${T}_{tr} = {\sum }_{n} {T}_{ref} \times {A}_{n} \times sin ( n \times Theta + {θ}_{n} ) \qquad ( 1 )$$

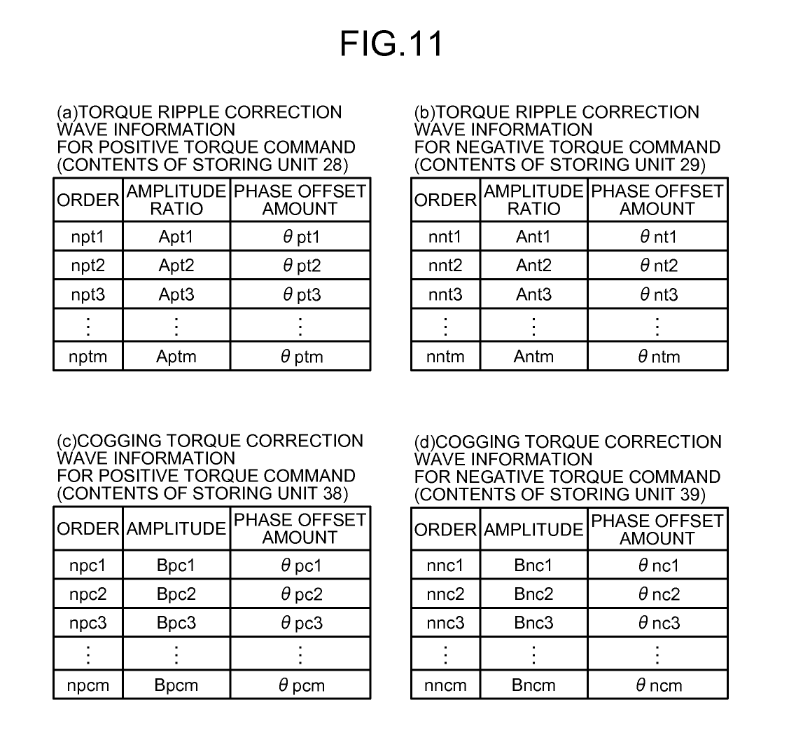

Note that an example of stored contents of the storing units 28 and 29 is shown in FIGS. 11(a) and 11(b) referred to below. The figures indicate that an amplitude ratio and a phase offset amount are stored in association with an order.

As explained above, according to the first embodiment, the configuration for correcting to reduce a torque ripple, which is one of two kinds of torque pulsations, is the configuration for preparing correction waveform information in the storing units in advance, monitoring a torque command input from the host apparatus, which is a state amount specifying a driving state of the motor that generates a torque ripple, determining whether a captured torque command is positive in polarity or negative in polarity, selecting waveform information corresponding to positive or negative of the torque command from the storing units, generating a sine wave-like correction wave for a periodical torque pulsation (torque ripple) based on the selected correction wave information, and generating, based on a corrected torque command obtained by combining the torque command and the generated correction waveform instead of the torque command input from the host apparatus, current commands of a d axis and a q axis given to the current control unit. Therefore, it is possible to appropriately perform correction for reducing a pulsation of torque (a torque ripple).

In this case, the correction wave information stored in the storing units includes harmonic order information and an amplitude ratio and a phase corresponding to the harmonic order information. The harmonic order information is different according to whether the torque command is positive in polarity of negative in polarity. Therefore, only necessary harmonic order information has to be stored in the storing units according to positive or negative of the torque command. Therefore, information such as the amplitude ratio and the phase that should be stored in association with the harmonic order information can be small. It is possible to reduce the capacity of the storing units.

### Second Embodiment

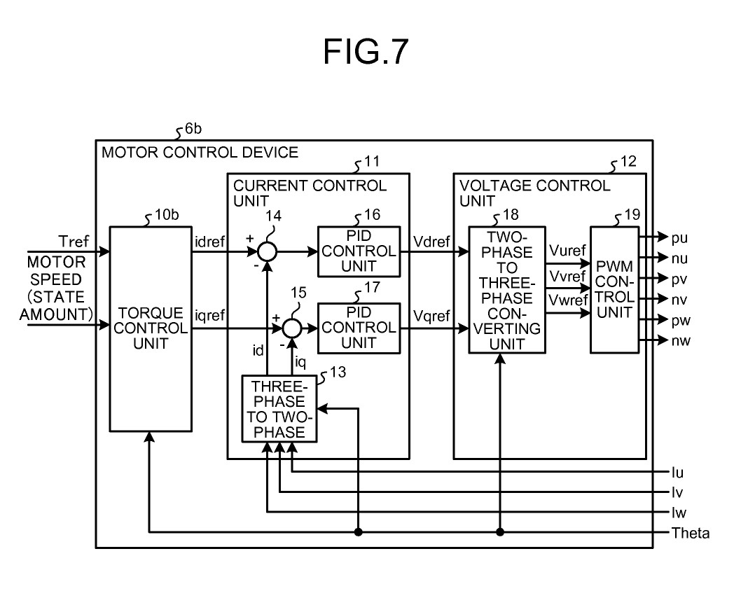

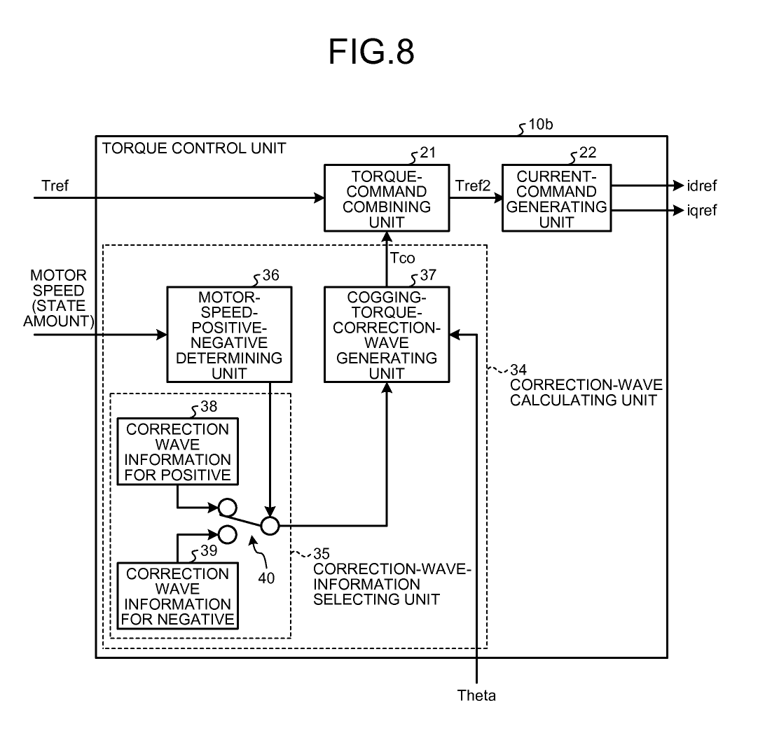

FIG. 7 is a block diagram of the configuration of a motor control device according to a second embodiment of the present invention. FIG. 8 is a block diagram of a configuration example of a torque control unit shown in FIG. 7. In the second embodiment, a correction system for reducing cogging torque in a pulsation of generated torque is explained. Components of a motor driving system are not shown because the components are the same as the components shown in FIG. 1. FIG. 7 (a motor control device) and FIG. (a torque control unit) are shown.

In FIG. 7, a motor control device 6b according to the second embodiment includes a torque control unit 10b instead of the torque control unit 10a in the motor control device 6a shown in FIG. 2 (the first embodiment). The other components are the same as the components shown in FIG. 2.

Besides the input of the torque command Tref from the host apparatus 8, motor speed, which is a state amount of the motor 1 specifying a driving state for generating the other one (cogging torque) of the two kinds of torque pulsations, is input to the torque control unit 10b. The motor speed is calculated from the detected motor position Theta.

As shown in FIG. 8, the torque control unit 10b includes a correction-wave calculating unit 34 instead of the correction-wave calculating unit 20 in the torque control unit 10a shown in FIG. 3 (the first embodiment). The correction-wave calculating unit 34 includes a correction-wave-information selecting unit 35, a motor-speed determining unit 36, and a cogging-torque-correction-wave generating unit 37 respectively instead of the correction-wave-information selecting unit 24, the torque-command-positive-negative determining unit 25, and the torque-ripple-correction-wave generating unit 26 in the correction-wave calculating unit 20. The correction-wave-information selecting unit 35 includes a storing unit 38 configured to store correction wave information for positive, a storing unit 39 configured to store correction wave information for negative, and a selection circuit 40. The correction wave information stored in the storing units 38 and 39 includes a harmonic order and the amplitude and the phase of a correction wave for cogging torque correction.

Cogging torque is generated at a fixed magnitude without depending on the magnitude of generated torque. However, pulsations of different harmonic orders could occur at normal rotation time and reverse rotation time of a motor because of shape fluctuation of mechanical components such as a pulley, a gear, and a ball screw connected to a shaft end of the motor and the structure of a transmission system such as a backlash. Therefore, for example, when a positioning operation of the motor is performed, it occurs that a harmonic order of cogging torque correction necessary for obtaining a satisfactory positioning characteristic is different when the motor is stopped from a normal rotation state and when the motor is stopped from a reverse rotation state.

Therefore, in the second embodiment, the speed of the motor 1 is calculated from the detected motor position Theta and monitored. Positive and negative of the motor speed is determined by the motor-speed-positive-negative determining unit 36. Whether stored information of the correction-wave-information-for positive storing unit 38 is used or stored information of the correction-wave-for-negative storing unit 39 is used is switched by the selection circuit 40 based on a result of the determination.

The cogging-torque-correction-wave generating unit 37 generates a sine wave-like cogging torque correction wave Tco in the motor position Theta using the correction wave information stored in one of the correction-wave-information storing units 38 and 39 and outputs the cogging torque correction wave Tco to the torque-command combining unit 21. The amplitude of the cogging torque correction wave Tco is a fixed value not depending on the amplitude of the torque command Tref.

The torque-command combining unit 21 combines the torque command Tref input from the host apparatus 8 and the cogging torque correction wave Tco generated by the cogging-torque-correction-wave generating unit 37 and generates the corrected torque command Tref2.

The current-command generating unit 22 generates the d-axis current command idref and the q-axis current command iqref based on the corrected torque command Tref2 generated by the torque-command combining unit 21 and outputs the d-axis current command idref and the q-axis current command iqref to the current control unit 11. Consequently, a correction operation for reducing a cogging torque in generated torque of the motor 1 is implemented according to cooperated work of the current control unit 11 and the voltage control unit 12.

The correction wave information stored in the storing units 38 and 39 is explained. The correction wave information used for the generation of the cogging torque correction wave Tco includes harmonic order information, the amplitude of a harmonic (a correction wave), and the phase of the harmonic (the correction wave). In the storing units 38 and 39, the harmonic order information and the amplitude of a harmonic (a correction wave), and the phase of the harmonic (the correction wave) corresponding to the harmonic order information are stored in association with each other.

First, as the harmonic order information, it is preferable to set the rotary machine frequency of the motor as one order and store a plurality of harmonic orders consisting of multiples n (n is a natural number) of the one order. This is because the rotary machine frequency of the motor 1 depends on rotating speed and the motor 1 driven by electric power frequency-converted by the inverter circuit 3 can rotate at various kinds of rotating speed. Then, for example, when torque of the motor 1 rotating at 50 Hz, which is a component oscillating at 100 Hz, is corrected, “n=2” can be set. Therefore, it is possible to perform appropriate correction.

There has also been an idea for setting an electric frequency as one order. However, with this idea, it is difficult to cope with an order decimal times as large as an electrical angular frequency due to fluctuation in the permanent magnet included in the motor 1 and other machining errors. Therefore, it is preferable to set harmonic orders with the rotary machine frequency set as one order.

In the storing units 38 and 39, besides the harmonic order n, it is preferable to store, in association with the harmonic order n, an amplitude Bn of a harmonic of the order n and the phase offset amount θn. The second embodiment is different from the first embodiment in that, whereas the amplitude ratio An of the torque pulsation component of the harmonic order to the torque command Tref is stored in the first embodiment, the amplitude Bn of the torque pulsation is stored in the second embodiment. This is because the cogging torque does not depend on the generated torque.

When the above explanation is summarized as a numerical formula, the sine wave-like cogging torque correction wave Tco generated by the cogging-torque-correction-wave generating unit 37 is represented by Formula (2) using the multiple (the harmonic order) n, the amplitude Bn of the harmonic (the cogging torque correction wave Tco), and the phase offset amount θn.

$${T}_{co} = {\sum }_{n} {B}_{n} \times sin ( n \times Theta + {θ}_{n} ) \qquad ( 2 )$$

Note that an example of stored contents of the storing units 38 and 39 is shown in FIGS. 11(c) and 11(d) referred to below. The figures indicate that an amplitude and a phase offset amount are stored in association with an order.

As explained above, according to the second embodiment, for correcting to reduce cogging torque, which is the other torque pulsation, is the configuration for preparing correction waveform information in the storing units in advance, monitoring motor speed, which is a state amount specifying a driving state of the motor that generates cogging torque, determining whether the motor speed is positive in polarity or negative in polarity, selecting waveform information corresponding to positive or negative of the motor speed from the storing units, generating a sine wave-like correction wave for a periodical torque pulsation (torque ripple) based on the selected correction wave information, and generating, based on a corrected torque command obtained by combining the torque command and the generated correction waveform instead of the torque command input from the host apparatus, current commands of a d axis and a q axis given to the current control unit. Therefore, it is possible to appropriately perform correction for reducing a pulsation (cogging torque) of torque.

In this case, the correction wave information stored in the storing units includes harmonic order information and an amplitude and a phase corresponding to the harmonic order information. The harmonic order information is different according to whether the torque command is positive in polarity of negative in polarity. Therefore, only necessary harmonic order information only has to be stored in the storing units according to positive or negative of the torque command. Therefore, information such as the amplitude and the phase that should be stored in association with the harmonic order information can be small. It is possible to reduce the capacity of the storing units.

### Third Embodiment

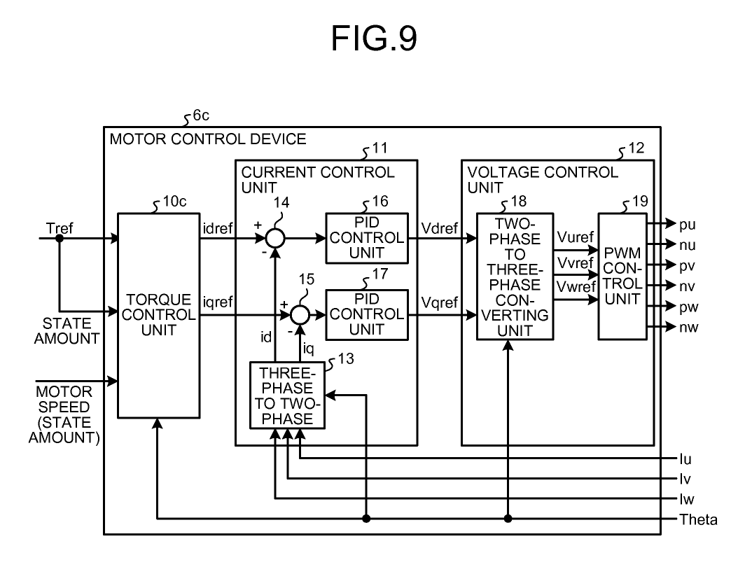

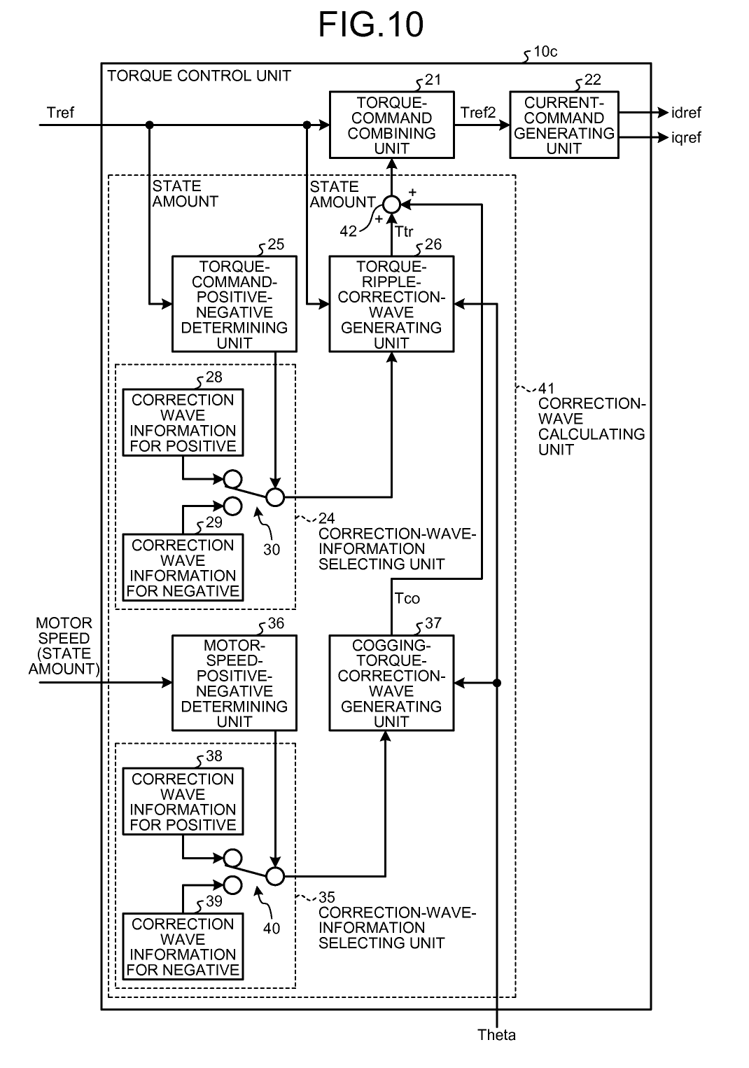

FIG. 9 is a block diagram of the configuration of a motor control device according to a third embodiment of the present invention. FIG. 10 is a block diagram of a configuration example of a torque control unit shown in FIG. 9. In the third embodiment, the torque ripple correction system explained in the first embodiment and the cogging torque correction system explained in the second embodiment are implemented in parallel. Components of a motor driving system are not shown because the components are the same as the components shown in FIG. 1. FIG. 9 (a motor control device) and FIG. 10 (a torque control unit) are shown.

As shown in FIG. 9, in a motor control device 6c according to the third embodiment, the torque command Tref output by the host apparatus 8 is captured into a torque control unit 10c. Further, the torque command Tref is input to the torque control unit 10c as one state amount and motor speed is input to the torque control unit 10c as another state amount.

In FIG. 10, a correction-wave calculating unit 41 in the torque control unit 10c can include, for example, the correction-wave calculating unit 20 shown in FIG. 3, the correction-wave calculating unit 34 shown in FIG. 8, and an adder 42. The adder 42 adds up the torque ripple correction wave Ttr generated by the correction-wave calculating unit 20 shown in FIG. 3 and the cogging torque correction wave Tco generated by the correction-wave calculating unit 34 shown in FIG. 8 and outputs the added-up torque ripple correction wave Ttr and cogging torque correction wave Tco to the torque-command combining unit 21.

The torque-command combining unit 21 combines the torque command Tref input from the host apparatus 8 and the torque ripple correction wave Ttr and the cogging torque correction wave Tco added up by the adder 42 and outputs the added-up torque command Tref, torque ripple correction wave Ttr, and cogging torque correction wave Tco to the current control unit 22 as the corrected torque command Tref2.

Consequently, it is possible to appropriately and simultaneously obtain the effects of the torque ripple correction and the cogging torque correction according to the torque command Tref and the motor speed, which are the state amounts of the motor.

Note that, in the correction-wave calculating unit 41 shown in FIG. 10, the configuration is shown in which the adder 42 adds up the torque ripple correction wave Ttr and the cogging torque correction wave Tco and outputs the added up torque ripple correction wave Ttr and cogging torque correction wave Tco to the torque-command combining unit 21. However, a configuration can also be adopted in which the adder 42 is omitted, the torque ripple correction wave Ttr and the cogging torque correction wave Tco are directly input to the torque-command combining unit 21, and the torque ripple correction wave Ttr and the cogging torque correction wave Tco are added up in the torque-command combining unit 21.

FIG. 11 is a diagram for explaining an example of stored contents of the four harmonic-order-information storing units shown in FIG. 10. An example of stored contents of the correction-wave-information storing unit 28 is shown in FIG. 11(a). An example of stored contents of the correction-wave-information storing unit 29 is shown in FIG. 11(b). An example of stored contents of the correction-wave-information storing unit 38 is shown in FIG. 11(c). An example of stored contents of the correction-wave-information storing unit 39 is shown in FIG. 11(d). In FIGS. 11(a) and 11(b), an order, an amplitude ratio, and a phase offset amount are shown. In FIGS. 11(c) and 11(d), an order, an amplitude, and a phase offset amount are shown. Note that, in FIG. 11, for convenience of explanation, positive is indicated by “p” and negative is indicated by “n”. For example, in the amplitude ratio, an amplitude ratio for positive is written as “Ap” and an amplitude ratio for negative is written as “An”. In the following explanation, “n” is a “natural number” as explained in the first to third embodiments.

In FIG. 11, all of orders and the like are represented by different signs. However, a part of the orders can be set the same. The orders and the like only have to be determined such that torque pulsations due to cogging torque and a torque ripple can be reduced.

In FIG. 11, harmonic order information in all combinations is information concerning m sets of orders, amplitude ratios (in the cogging torque, amplitudes), and phase offset amounts. However, the number of sets does not have to be the same.

Further, the amplitude ratio An can be a fixed value but can be a function {An(Tref, Theta)} of a torque command and motor speed. When the amplitude ratio A is set in this way, recreation of a torque command corresponding to a driving state of the motor can be performed more in detail. Therefore, the effect of reducing a pulsation of torque increases.

In addition, the phase offset amount θn can be a fixed value but can be a function of a torque command and motor speed {θn(Tref, Theta)}. When the phase offset amount θn is set in this way, recreation of a torque command corresponding to a driving state of the motor can be performed more in detail. Therefore, the effect of reducing a pulsation of torque increases.

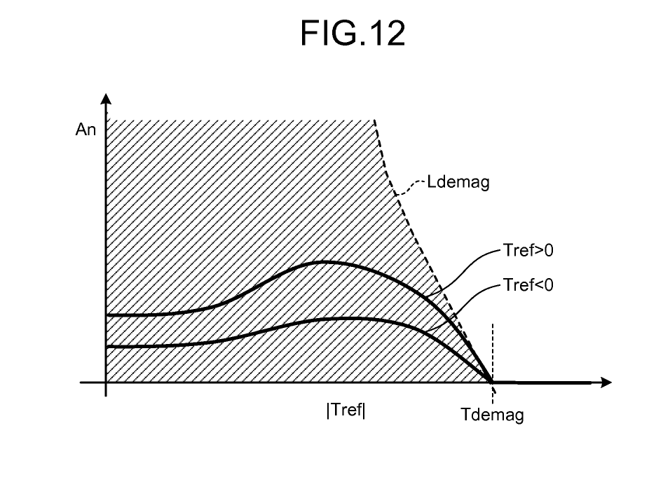

FIG. 12 is a diagram of a relation between the amplitude ratio An of a harmonic (a correction wave) and an absolute value of the torque command Tref. In FIG. 12, demagnetization start torque Tdemag and a demagnetization boundary line Ldemag are shown. The demagnetization start torque Tdemag means a torque value of a boundary where the permanent magnet included in the motor 1 causes compound demagnetization with heat and an opposing magnetic field when the motor 1 is about to generate torque equal to or larger than the demagnetization start torque Tdemag. The demagnetization boundary line Ldemag means a boundary line for preventing a combined wave (the corrected torque command Tref2) of the torque ripple correction wave Ttr, which is generated based on the torque command Tref and the amplitude ratio An, and the original torque command Tref from exceeding the demagnetization start torque Tdemag.

The corrected torque command Tref2 needs to be limited not to exceed the demagnetization start torque Tdemag. To limit the corrected torque command Tref2, it is desirable to implement at least one of two methods explained below.

As a first method, as shown in FIG. 12, the amplitude ratio An is preferably zero in a region where the absolute value of the command torque Tref is equal to or larger than the demagnetization start torque Tdemag. It is desirable to store the demagnetization start torque Tdemag in a storage device in the motor control device as a parameter or include the demagnetization start torque Tdemag in a function of the amplitude ratio An in the harmonic order information stored in the correction-wave-information storing units 28 and 29 in advance.

As a second method, the amplitude ratio A is preferably set in a region smaller than the demagnetization boundary line Ldemag (a hatching portion in FIG. 12) in a region where the absolute value of the torque command Tref is smaller than the demagnetization start torque Tdemag.

Formulas specifying a relation among the torque command Tref, the amplitude ratio An, and the demagnetization start torque Tdemag and the demagnetization boundary line Ldemag for preventing the corrected torque command Tref2 from exceeding the demagnetization start torque Tdemag are shown below.

The corrected torque command Tref2 can be represented as Tref2=|Tref|+An×|Tref|×sin(n×Theta+θn). A maximum of the corrected torque command Tref2 is obtained when sin(n×Theta+θn)=1. Therefore,

|Tref2|max=|Tref|+An×|Tref| (3)

To prevent |Tref2|max from exceeding the demagnetization start torque Tdemag, the following formula needs to hold:

|Tref|+An×|Tref|≦Tdemag (4)

When Formula (4) is arranged, the following formula is obtained:

|Tref|(1+An)Tdemag

(1+An)≦Tdemag/|Tref|

An(Tdemag/|Tref|)−1 (5)

The following Formula (6) adopting an equal sign in Formula (5) is a formula representing the demagnetization boundary line Ldemag:

An=(Tdemag/|Tref|)−1 (6)

Therefore, it is possible to understand from Formula (5) that, when the amplitude ratio An is retained as a function of the torque command Tref, a curve of the function has to be present in the hatching portion of FIG. 12. That is, the amplitude ratio An has to be present in a region where the relation of Formula (5) is satisfied, in other words, a region smaller than the demagnetization boundary line Ldemag indicated by Formula (6) in a region where the absolute value of the torque command Tref is smaller than the demagnetization start torque Tdemag.

As explained above, according to the third embodiment, it is possible to implement the torque ripple correction system explained in the first embodiment and the cogging torque correction system explained in the second embodiment in parallel.

In the implementation of the torque ripple correction system, there is an effect that it is possible to prevent a function loss of the motor 1 due to demagnetization of the permanent magnet included in the motor 1 by setting an amplitude ratio to a certain harmonic order in the correction wave information stored in the correction-wave-information-for-positive storing unit 28 and the correction-wave-information-for-negative storing unit 29 to zero in a region equal to or larger than the demagnetization start torque Tdemag in advance or setting the amplitude ratio in a region smaller than the demagnetization boundary line Ldemag.

### Fourth Embodiment

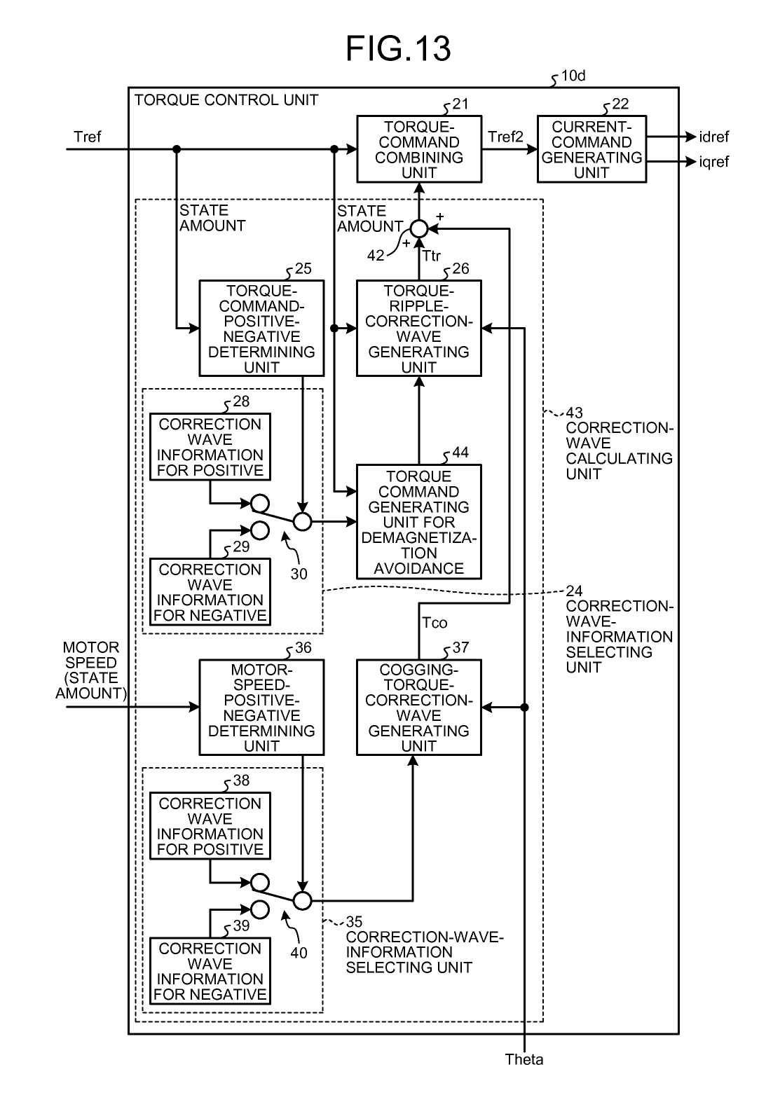

FIG. 13 is a block diagram of another configuration example of the torque control unit shown in FIG. 9 shown as a fourth embodiment of the present invention. A torque control unit 10d shown in FIG. 13 includes a correction-wave calculating unit 43 instead of the correction-wave calculating unit 41 in the torque control unit 10c shown in FIG. 10. In the correction-wave calculating unit 43, “a torque-command generating unit 44 for demagnetization avoidance”, to which the torque command Tref is input, is provided between an output end of the selection circuit 30 and an input end of the torque-ripple-correction-wave generating unit 26.

As explained in the third embodiment, the amplitude ratio An is set in the region smaller than the demagnetization boundary line Ldemag (the hatching portion in FIG. 12) in the region where the absolute value of the torque command Tref is smaller than the demagnetization start torque Tdemag. That is, the amplitude ratio An is specified in a region of

0≦An≦{(Tdemag/|Tref|)−1} (7)

The torque-command generating unit 44 for demagnetization avoidance functions as a variable limiter for applying Formula (7) to the absolute value of the torque command Tref when the selection circuit 30 does not select both the storing units 28 and 29 because, for example, the amplitude ratio An stored in the storing units 28 and 29 is a fixed value. The torque-command generating unit 44 generates the amplitude ratio An in a region portion specified by Formula (7) (a torque command for demagnetization avoidance) and outputs the amplitude ratio An to the torque-ripple-correction-wave generating unit 26.

That is, when the selection circuit 30 does not select both the storing units 28 and 29, the torque-command generating unit 44 for demagnetization avoidance variably generates the amplitude ratio An in the region portion specified by Formula (7) based on Formula (6) when the absolute value of the torque command Tref is present on a limiter upper limit value side and fixes the amplitude ratio An to zero when the absolute value of the torque command Tref is present on a limiter lower limit value side.

By configuring the torque control unit 10d as explained above, an effect is obtained that it is possible to prevent a function loss of the motor 1 due to demagnetization of the permanent magnet included in the motor 1 without performing the special setting explained with reference to FIG. 12 concerning the correction wave information stored in the correction-wave-information-for-positive storing unit 28 and the correction-wave-information-for-negative storing unit 29 in the third embodiment.

Note that, in the fourth embodiment, an application example to the third embodiment is explained. However, the fourth embodiment can also be applied to the first embodiment.

### Fifth Embodiment

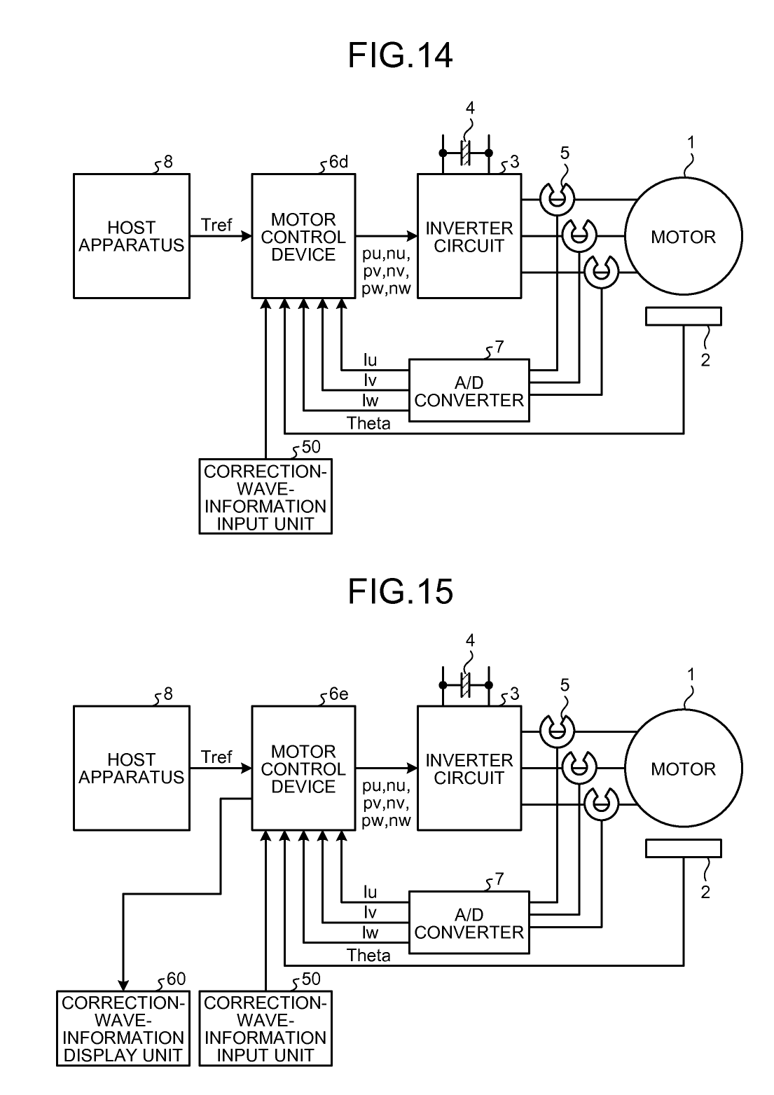

FIG. 14 is a block diagram of a configuration example of a motor driving system including a motor control device according to a fifth embodiment of the present invention. Note that, in FIG. 14, components same as or equivalent to the components shown in FIG. 1 (the first embodiment) are denoted by the same reference numerals and signs. Components related to the fifth embodiment are mainly explained below.

In FIG. 14, a correction-wave-information input unit 50 can be connected to a motor control device 6d according to the fifth embodiment in the configuration of the motor control device 6a shown in FIG. 1 (the first embodiment). The correction-wave-information input unit 50 includes a keyboard, a touch panel, or push buttons.

That is, although not shown in the figure, referring to FIG. 2 (the motor control device 6a) and FIG. 3 (the torque control unit 10a), a writing control circuit for the correction-wave-information storing units 28 and 29 is provided in the motor control device 6a or in the torque control unit 10a. In the torque ripple correction system, the writing control circuit writes, in the correction-wave-information storing units 28 and 29, harmonic order information, an amplitude ratio, and a phase offset amount, which are input by operating the correction-wave-information input unit 50, as one set.

By configuring the motor control device 6d as explained above, for example, when the motor 1 driven by the motor control device 6d is changed, it is possible to input correction wave information for positive and for negative for torque ripple correction suitable for the motor 1 and set the correction wave information in the correction-wave-information storing units 28 and 29.

Note that, in the fifth embodiment, an application example to the first embodiment is explained. However, the fifth embodiment can also be applied to the second to fourth embodiments. That is, it is possible to set correction wave information for positive and for negative for cogging torque correction (a set of harmonic order information, an amplitude, and a phase) by operating the correction-wave-information input unit 50.

### Sixth Embodiment

FIG. 15 is a block diagram of a configuration example of a motor driving system including a motor control device according to a sixth embodiment of the present invention.

In FIG. 15, a correction-wave-information display unit 60 can also be connected to a motor control device 6e according to the sixth embodiment in addition to the correction-wave-information input unit 50 shown in FIG. 14. The correction-wave-information display unit 60 includes an LED display or a monitor for a personal computer.

That is, although not shown in the figure, referring to FIG. 2 (the motor control device 6a) and FIG. 3 (the torque control unit 10a), a writing control circuit and a readout control circuit for the correction-wave-information storing units 28 and 29 are provided in the motor control device 6a or the torque control unit 10a. The writing control circuit writes correction wave information, which is input by operating the correction-wave-information input unit 50, in the harmonic-order-information storing units 28 and 29.

When an instruction for display output is input by operating the correction-wave-information input unit 50, the readout control circuit displays contents of a designated storing unit of the correction-wave-information storing units 28 and 29 on the correction-wave-information display unit 60.

By configuring the motor control device 6e as explained above, for example, when the motor 1 driven by the motor control device 6d is changed, it is possible to input correction wave information for positive and for negative for torque ripple correction suitable for the motor 1 and set the correction wave information in the correction-wave-information storing units 28 and 29. In addition, it is possible to check the stored correction wave information for torque ripple correction. Therefore, it is possible to appropriately correct a pulsation of torque (a torque ripple).

Note that, in the sixth embodiment, an application example to the fifth embodiment (i.e., the first embodiment) is explained. However, the sixth embodiment can also be applied to the second to fourth embodiments.

### Seventh Embodiment

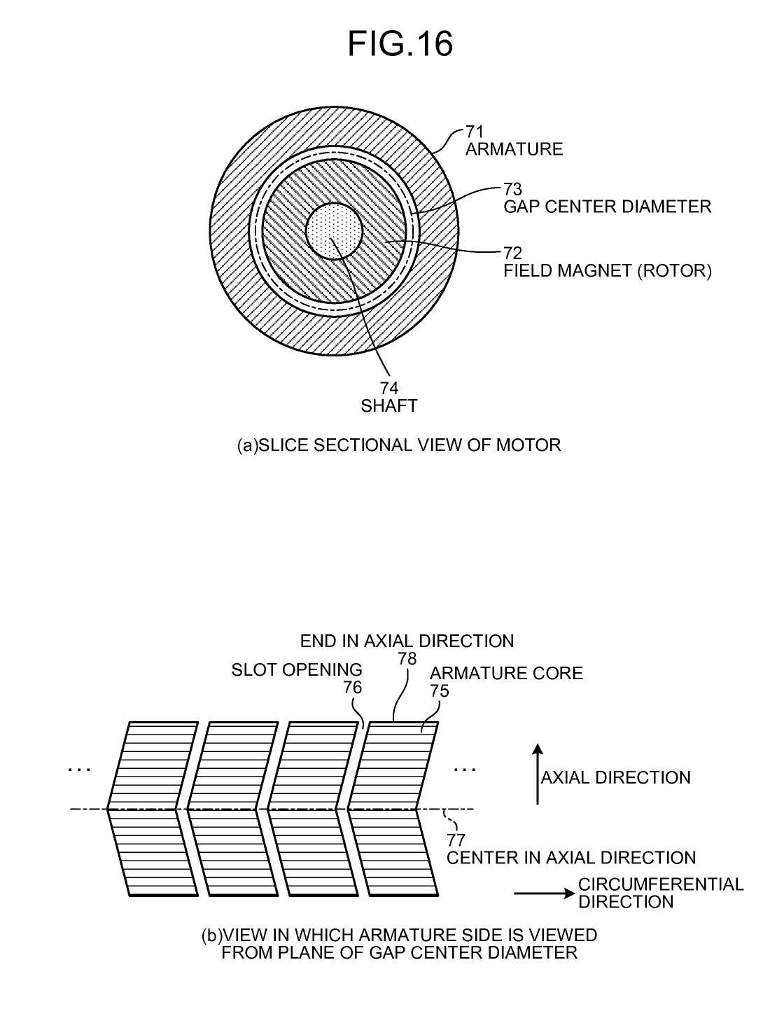

The motor 1 driven by the motor control devices explained in the first to sixth embodiments is a permanent magnet type motor. A V-shaped skew slot or a V-shaped step skew slot is formed in at least one of a field magnet side and an armature side of the motor 1. In a seventh embodiment, the structure of the V-shaped skew slot or the V-shaped step skew slot is explained with reference to FIGS. 16 to 19.

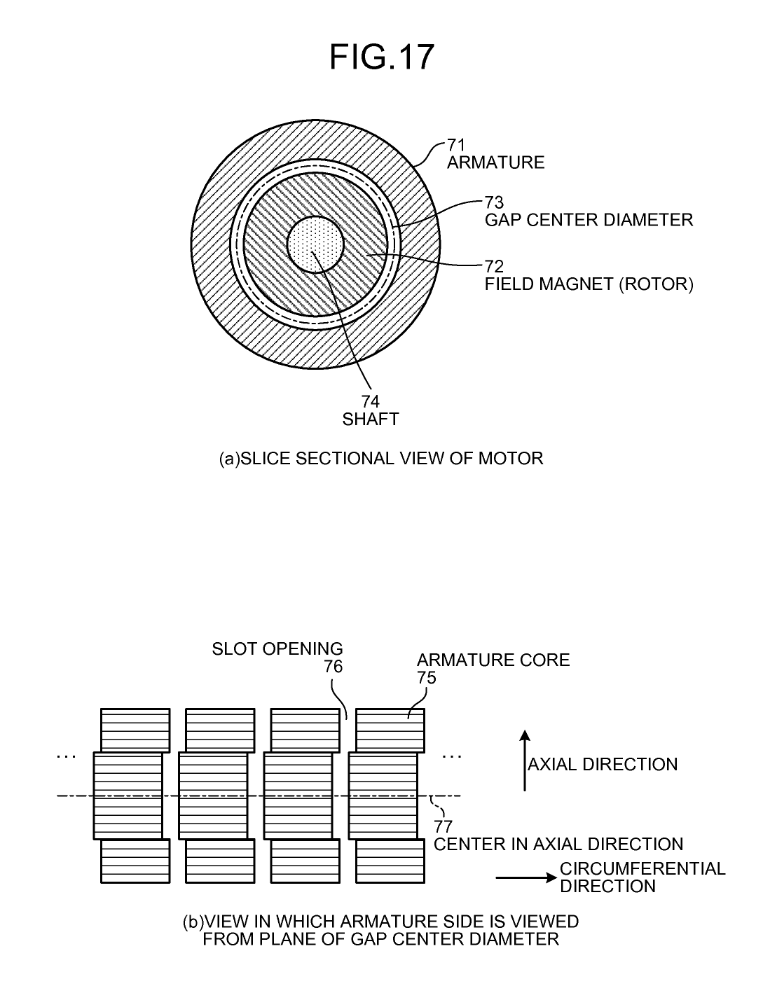

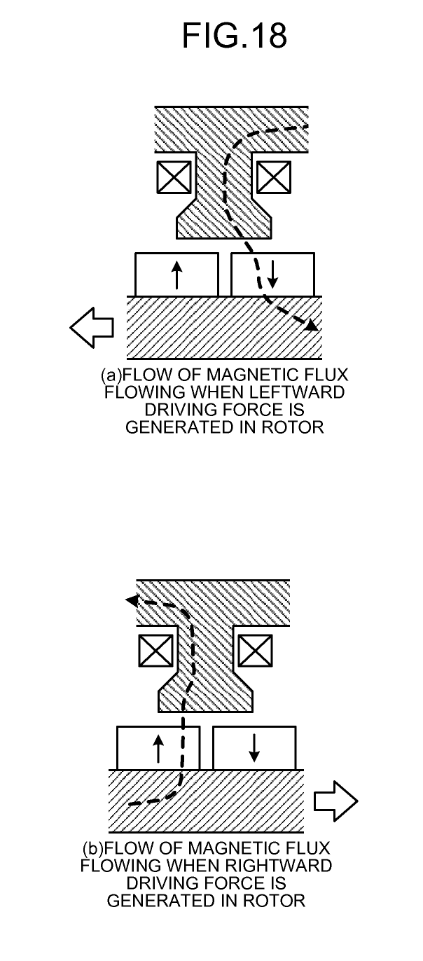

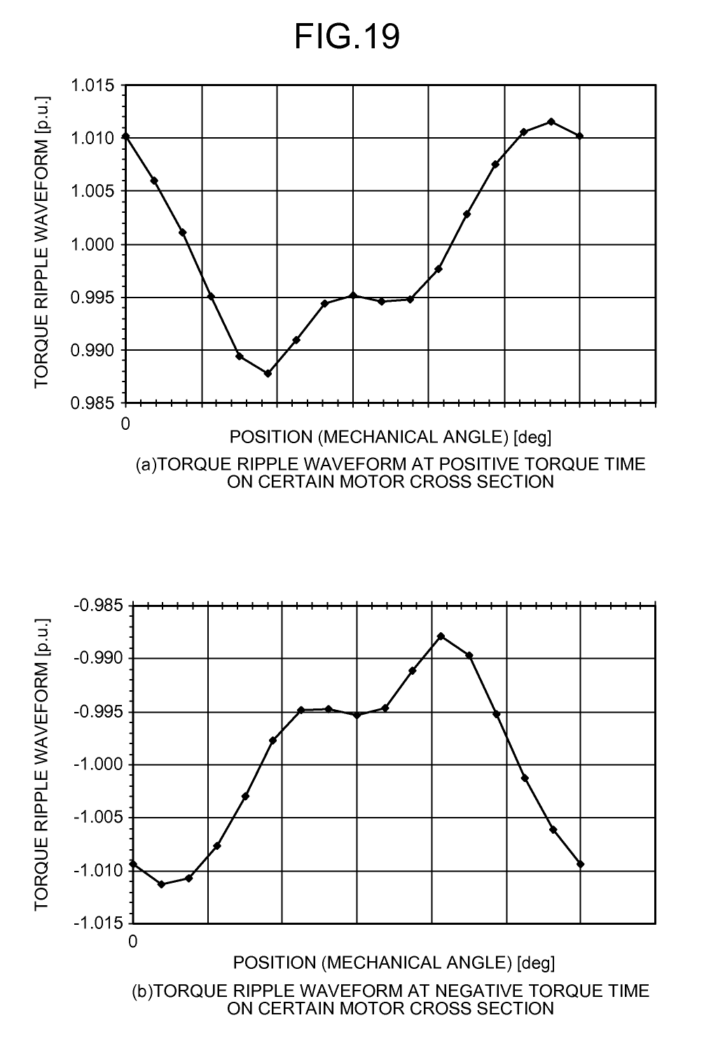

FIGS. 16 and 17 are conceptual diagrams of a configuration example of a driven motor shown as the seventh embodiment of the present invention. FIG. 18 is a diagram for explaining a flow of a magnetic flux flowing when a driving force is generated by the motor shown in FIGS. 16 and 17. FIG. 19 is a diagram of a torque ripple waveform in a motor cross section of the motor shown in FIGS. 16 and 17.

In FIG. 16, a formation example of the V-shaped skew slot is shown. In FIG. 17, a formation example of the V-shaped step skew slot is shown. FIG. 16(a) and FIG. 17(a) are slice sectional views of the driven motor 1. For example, as shown in FIG. 16(a) and FIG. 17(a), in the motor 1, an armature 71 and a field magnet 72 (a rotor) fixed to the outer circumference of a shaft 74 are arranged substantially concentrically via a gap and rotatably supported by a not-shown supporting mechanism.

FIG. 16(b) and FIG. 17(b) are views in which the armature 71 side is viewed from a concentric plane of the armature 71 and the field magnet 72 including a gap center diameter 73 shown in FIG. 16(a) and FIG. 17(a). Therefore, in FIG. 16(b) and FIG. 17(b), an inner circumference side surface of the armature 71 is seen. As shown in FIG. 16(b), in the V-shape skew slot, a large number of armature cores 75 and a large number of slot openings 76 are alternately arranged in a circumferential direction in a form in which a character V of alphabets rotates to the right 90°. The character V is substantially symmetrical to a center 77 in the axial direction of the armature 71. As shown in FIG. 17(b), the V-shaped step skew slot has a structure same as the V-shaped skew slot.

Note that, in FIG. 16(a) and FIG. 17(a), a motor of a so-called inner rotor type in which the armature 71 is arranged on the outer side of the field magnet 72 is shown. However, the present invention can be applied to an outer rotor type, the inside and the outside of which are opposite to the inside and the outside of the inner rotor type.

A skew technology in a motor is a technique for solving various harmonic problem by shifting an armature core in the axial direction while skewing the armature core. However, the structure of the skew is not limited to the structure shown in FIGS. 16 and 17. A phenomenon focused on by the present invention in which a harmonic order of a torque ripple is different at positive torque time and negative torque time is caused by the magnetic structure of the motor. The phenomenon in which the harmonic order of the torque ripple is different at the positive torque time and the negative torque time is a phenomenon that could conspicuously occur even if the structure of the skew is not the V shape or even if the structure of the skew is not rotationally symmetrical to the center 77 in the axial direction of the armature.

A theory for explaining the phenomenon in which the harmonic order of the torque ripple is different at the positive torque time and the negative torque time is explained concerning the torque ripple with reference to, for example, FIG. 16(b). According to the theory, when torque ripples from a torque ripple generated by the armature core 75 present in the center 77 in the axial direction to a torque ripple generated by the armature core 75 present at an end 78 in the axial direction are integrated, a component of a specific harmonic order in the torque ripples is cancelled.

However, this theory is based on an assumption that torque ripples assumed on a two-dimensional cross section shown in FIG. 16(a) are the same in all axial direction positions. Actually, there is, for example, magnetic flux leaks in three-dimensional axial directions at ends in the axial directions. Torque ripples on cross sections are not the same. Even in the same rotating position and on the same motor cross section, as shown in FIG. 18, a way of flowing of a magnetic flux is different and a torque ripple is different when positive torque is output and when negative torque is output.

A result obtained by analyzing a torque waveform of a motor cross section by an electromagnetic field FEM (a finite element method) is shown in FIG. 19. In FIG. 19(a), positive torque is output. In FIG. 19(b), negative torque is output. In both FIGS. 19(a) and 19(b), the abscissas indicate the same position (mechanical angle). It is seen from FIGS. 19(a) and 19(b) that the phase of a torque ripple is different when the positive torque is output and when the negative torque is output even in the same rotating position and on the same motor cross section. When this phenomenon and a three-dimensional influence are combined, a phenomenon sometimes occurs in which a harmonic order of a torque ripple at positive torque time and a harmonic order of a torque ripple at negative torque time are different.

Therefore, when the permanent magnet type motor 1 applied with the V-shaped skew slot or step skew slot is driven, a harmonic order appearing in a torque ripple is different in positive torque and negative torque. Therefore, it is possible to effectively reduce a torque pulsation by using the motor control devices explained in the first to sixth embodiments.

However, the motor 1 controlled to be driven by the motor control devices explained in the first to sixth embodiments is the permanent magnet type motor but it is not always a requirement that the V-shaped skew slot or step skew slot is applied to the motor 1. The motor 1 is configured as explained below. When the components are denoted by the reference numerals and signs shown in FIGS. 16 and 17, the motor 1 is a permanent magnet type motor including the armature core 75 in which steel plates having slots are laminated, the armature 71 in which armature coils are arranged in the slots, and the field magnet 72 including a permanent magnet disposed such that magnetic poles are opposite to each other in relative rotating directions. The armature 71 and the field magnet 72 are supported rotatably to each other via an air gap. When the surface of the armature core 75 and the surface of the magnetic poles, which can be observed from the air gap, are observed, at least one surface of the surface of the armature core 75 and the surface of the magnetic poles is rotationally asymmetrical around a certain one point where the center line in the laminating direction of the armature core 75 is present.

### Eighth Embodiment

In an eighth embodiment, a permanent magnet type motor includes the armature core in which the steel plates having the slots are laminated, the armature in which the armature coils are disposed in the slots, and the field magnet including the permanent magnet disposed such that the magnetic poles are opposite to each other in the relative rotating directions explained in the seventh embodiment. The armature and the field magnet are supported rotatably to each other via the air gap. The motor is configured such that, when the number of magnetic poles on the field magnet side is represented as P and the number of slots on the armature side is represented as Q, a ratio P/Q of the number of magnetic poles P and the number of slots Q is 2/3<P/Q<4/3.

In such a permanent magnet type motor 1, an order of a torque pulsation with respect to an electrical angle tends to be a decimal fraction. Therefore, for example, when fluctuation often occurs in the shapes and magnetization amounts of magnets included in the poles, torque pulsations in a Pth order and orders natural number times as large as the Pth order tend to occur.

However, in this specification, a harmonic order of a torque pulsation is defined with a rotary mechanical angular frequency set as a primary order. Therefore, even in an order that is a decimal fraction with respect to an electrical angular frequency, it is possible to easily generate a correction wave and reduce a torque pulsation.

That is, the permanent magnet type motor 1, in which the ratio P/Q is 2/3<P/Q<4/3, can effectively reduce a torque pulsation if the permanent magnet type motor 1 is controlled to be driven by the motor control devices explained in the first to sixth embodiment.

A production method is pursued to reduce pulsations of a Pth order and a Qth order caused by a machining error. However, there are compromises due to costs and the like. Therefore, it is difficult to reduce the pulsations to be smaller than a fixed level.

However, in the permanent magnet type motor 1, in which the ratio P/Q is 2/3<P/Q<4/3, components of a sixth order and an order of a least common multiple of P and Q with respect to an electrical angular frequency, which are components in which a torque ripple and cogging torque generally occur, decrease if normal motor design is performed. This indicates that at least one of P and Q only has to be set as harmonic order information.

That is, in the eighth embodiment, there is an effect that it is possible to provide a system with a small torque pulsation as a motor driving system simply by setting at least one of the Pth order and the Qth order as harmonic order information.

### INDUSTRIAL APPLICABILITY

As explained above, the motor control device according to the present invention is useful as a motor control device that can perform, with a simple configuration, correction for appropriately reducing two kinds of torque pulsations according to positive or negative of a state amount specifying a driving state for causing a pulsation in generated torque of a motor.

### REFERENCE SIGNS LIST

1 Motor
2 Position sensor
3 Inverter circuit
4 Capacitor
5 Current sensors
6a, 6b, 6c, 6d, 6e Motor control devices
7 A/D converter
8 Host apparatus
10a, 10b, 10c, 10d Torque control units
11 Current control unit
12 Voltage control unit
13 Three-phase to two-phase converting unit
14, 15 Subtracters
16, 17 PID control units
18 Two-phase to three-phase converting unit
19 PWM control unit
20, 34, 41 Correction-wave calculating units
21 Torque-command combining unit
22 Current-command generating unit
24 Correction-wave-information selecting unit
25 Torque-command-positive-negative determining unit
26 Torque-ripple-correction-wave generating unit
28, 38 Storing units storing correction wave information for positive
29, 39 Storing units storing correction wave information for negative
30, 40 Selection circuits
36 Motor-speed-positive-negative determining unit
37 Cogging-torque-correction-wave generating unit
42 Adder
50 Correction-wave-information input unit
60 Correction-wave-information display unit
71 Armature
72 Field magnet (rotor)
73 Gap center diameter
74 Shaft
75 Armature core
76 Slot openings

1. A motor control device for controlling a motor based on an input torque command, comprising:
a positive-negative determining unit for determining positive or negative by indicating whether a state amount specifying a driving state for causing a pulsation in generated torque of the motor is positive polarity or negative polarity;
a correction-wave-information selecting unit for selecting, from a storing unit that stores correction wave information, correction wave information corresponding to positive or negative indicated by a determination result of the positive-negative determining unit; and
a correction-wave generating unit for generating a sine wave-like correction wave with respect to a periodical torque pulsation, based on the selected correction wave information,
wherein the motor control device controls the motor based on a corrected torque command obtained by combining the torque command and the generated correction wave, instead of the input torque command.

2. The motor control device according to claim 1,
wherein the state amount of the motor is the input torque command,
wherein the correction-wave-information selecting unit selects an order corresponding to the positive or negative indicated by the determination result of the positive-negative determining unit out of harmonic order information stored in the storing unit as the correction wave information, and
wherein the correction-wave generating unit generates a correction wave whose amplitude depends on the torque command, based on the selected order.

3. The motor control device according to claim 2, wherein the correction-wave-information selecting unit further selects an amplitude ratio of an amplitude of the correction wave, which is stored in the storing unit in association with the harmonic order information as the correction wave information, to the torque command, and gives the amplitude ratio to the correction-wave generating unit.

4. The motor control device according to claim 3, wherein the amplitude ratio is zero in a region where an absolute value of the torque command is larger than demagnetization start torque.

5. The motor control device according to claim 3, wherein the amplitude ratio An is set in a region where a relation of a formula An≦(Tdemag/|Tref|)−1 is satisfied in a region where an absolute value of the torque command Tref is smaller than the demagnetization start torque Tdemag.

6. The motor control device according to claim 2, wherein the correction-wave-information selecting unit further selects a phase of the correction wave, which is stored in the storing unit in association with the harmonic order information as the correction wave information, and gives the phase of the correction wave to the correction-wave generating unit.

7. The motor control device according to claim 2, wherein an input unit that can select correction wave information including the harmonic order information, the amplitude ratio, and the phase is connected to the storing unit.

8. The motor control device according to claim 2, wherein a display unit that can display correction wave information including the harmonic order information, the amplitude ratio, and the phase stored in the storing unit is connected.

9. The motor control device according to claim 1,
wherein the state amount of the motor is motor speed,
wherein the correction-wave-information selecting unit selects an order corresponding to the positive or negative indicated by the determination result of the positive-negative determining unit out of harmonic order information stored in the storing unit as the correction wave information, and
wherein the correction-wave generating unit generates a correction wave whose amplitude is a fixed value not depending on the torque command, based on the selected order.

10. The motor control device according to claim 7, wherein the correction-wave-information selecting unit further selects an amplitude of the correction wave, which is stored in the storing unit in association with the harmonic order information as the correction wave information, and gives the amplitude to the correction-wave generating unit.

11. The motor control device according to claim 7, wherein the correction-wave-information selecting unit further selects a phase of the correction wave, which is stored in the storing unit in association with the harmonic order information as the correction wave information, and gives the phase to the correction-wave generating unit.

12. The motor control device according to claim 9, wherein an input unit that can select correction wave information including the harmonic order information, the amplitude, and the phase is connected to the storing unit.

13. The motor control device according to claim 9, wherein a display unit that can display correction wave information including the harmonic order information, the amplitude, and the phase stored in the storing unit is connected to the motor control device.

14. The motor control device according to claim 1,
wherein the motor includes:
an armature core in which steel plates having slots are laminated;
an armature in which armature coils are disposed in the slots; and
a field magnet including a permanent magnet disposed such that magnetic poles are opposite to each other in moving directions,
wherein the armature and the field magnet are supported movably to each other via an air gap, and
wherein when a surface of the armature core and a surface of the magnetic poles, which can be observed from the air gap, are observed, at least one of the surface of the armature core and the surface of the magnetic poles is rotationally asymmetrical around a certain one point where a center line in a laminating direction of the armature core is present.

15. The motor control device according to claim 1,
wherein the motor includes:
an armature core in which steel plates having slots are laminated;
an armature in which armature coils are disposed in the slots; and
a field magnet including a permanent magnet disposed such that magnetic poles are opposite to each other in moving directions,
wherein the armature and the field magnet are supported movably to each other via an air gap, and
wherein where a number of the slots is represented as Q and a number of the magnetic poles is represented as P, a ratio P/Q is set such that 2/3<P/Q<4/3 holds.

16. The motor control device according to claim 15, wherein at least one of the number of magnetic poles P and the number of slots Q is set as an order of the harmonic order information stored in the storing unit as the correction wave information.

17. The motor control device according to claim 8, wherein the correction-wave-information selecting unit further selects a phase of the correction wave, which is stored in the storing unit in association with the harmonic order information as the correction wave information, and gives the phase to the correction-wave generating unit.
